(19) United States
(12) Patent Application Publication
(10) Pub. No.: US 2025/0103254 A1
(43) Pub. Date: Mar. 27, 2025

(54) INFORMATION PROCESSING APPARATUS AND CONTROL METHOD FOR THE SAME, AND STORAGE MEDIUM

(71) Applicant: CANON KABUSHIKI KAISHA, Tokyo (JP)

(72) Inventor: HIROKI ITO, Chiba (JP)

(21) Appl. No.: 18/892,149

(22) Filed: Sep. 20, 2024

(30) Foreign Application Priority Data
Sep. 21, 2023 (JP) 2023-154188

(51) Int. Cl. G06F 3/12

(52) U.S. Cl. CPC G06F 3/1221; G06F 3/1229; G06F 3/1253

(57) ABSTRACT

An information processing apparatus includes an operation acceptance unit configured to accept an operation from a user, a control unit configured to accept a signal from the operation acceptance unit, a generation unit configured to accept a signal from the operation acceptance unit and generate a recovery signal, and a power source control unit configured to shift, based on the recovery signal, a power state of the information processing apparatus from a first power state in which the control unit is not energized to a second power state in which the control unit is energized, in which in the second power state, the generation unit does not generate the recovery signal even when the signal from the operation acceptance unit is accepted in the second power state, and the generation unit generates the recovery signal when the signal from the operation acceptance unit is accepted in the first power state.

### BACKGROUND

### Field of the Disclosure

The present disclosure relates to an information processing apparatus and a control method for the information processing apparatus, and a storage medium.

### Description of the Related Art

An information processing apparatus such as an image formation apparatus may include an input device such as a touch panel or a numerical keypad, a display device such as a liquid crystal display (LCD), an exclusive operation unit constituted by a control board in which a central processing unit (CPU) is installed, and the like. The operation unit is configured to receive image data generated by a main control unit of the information processing apparatus from the main control unit and perform screen display by the display device based on the received image data.

At the same time, power saving is demanded in such an information processing apparatus. A technique has been proposed with which when the information processing apparatus operates in a power save mode, a device configured to supply power is switched in accordance with a state of the power save mode to save power. According to a technique disclosed in Patent Literature 1, an operation unit includes a circuit configured to detect an operation from a user, and based on an input instruction of the user, and a device configured to supply power to components related a printing operation and an information processing operation is switched.

### SUMMARY

The present disclosure aims at realizing, when an information processing apparatus operates in a first power state in which a sub CPU is not energized, power saving of an operation unit by eliminating power in an unnecessary component in the operation unit without energizing at least the sub CPU in the first power state while ensuring convenience that shifting is enabled from the first power state in which the sub CPU is not energized to a second power state in which the sub CPU is energized by having accepted an operation from a user.

In view of the above, an information processing apparatus according to embodiments of the present disclosure includes an operation acceptance unit configured to accept an operation from a user, a control unit configured to accept a signal from the operation acceptance unit, a generation unit configured to accept a signal from the operation acceptance unit and generate a recovery signal, and a power source control unit configured to shift, based on the recovery signal, a power state of the information processing apparatus from a first power state in which the control unit is not energized to a second power state in which the control unit is energized, in which the generation unit does not generate the recovery signal even when the signal from the operation acceptance unit is accepted in the second power state, and the generation unit generates the recovery signal when the signal from the operation acceptance unit is accepted in the first power state.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of an image formation system.

FIG. 2 is a block diagram illustrating a hardware configuration example of an image formation apparatus.

FIG. 3 is a block diagram illustrating a hardware configuration example of a power source reset control unit.

FIG. 4 is a block diagram illustrating a hardware configuration example of a reset control unit.

FIG. 5A is a block diagram illustrating a hardware configuration example of a recovery signal generation unit, and FIG. 5B is a block diagram illustrating an energized state of each of blocks connected to the recovery signal generation unit in a power saving state.

FIG. 6 is a timing chart illustrating behavior examples of internal signals and main power sources and signals which are input and output in the power source reset control unit according to one or more aspects of the present disclosure.

FIG. 7 is a timing chart illustrating behavior examples of the internal signals and the main power sources and signals which are input and output in the power source reset control unit according to one or more aspects of the present disclosure.

FIG. 8 is a timing chart illustrating behavior examples of internal signals and main power sources and signals which are input and output in the power source reset control unit according to one or more aspects of the present disclosure.

### DESCRIPTION OF THE EMBODIMENTS

Hereinafter, embodiments will be described with reference to the drawings. It is noted however that components described in the following embodiments are merely exemplifications and are not intended to be limited to those.

### First Embodiment

### System Configuration

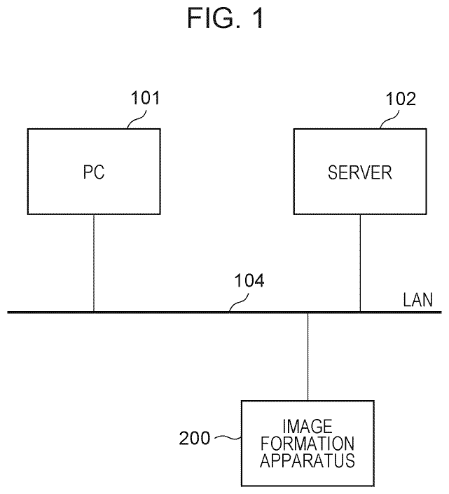

FIG. 1 illustrates a configuration example of an image formation system according to an embodiment. According to the present embodiment, an example will be described in which the present embodiment is applied to an image formation apparatus configured to perform image formation as an example of an information processing apparatus. It is noted that the present embodiment can be applied to an information processing apparatus as long as the information processing apparatus includes a control unit configured to generate image data for screen display and an operation unit provided with a display unit and configured to display a screen on the display unit based on the image data generated by the control unit to accept a user operation. For example, the present embodiment can also be applied to an information processing apparatus such as a printing apparatus, a scanning apparatus, a copying machine, and a facsimile apparatus.

In the system illustrated in FIG. 1, a personal computer (PC) 101, a server 102, and an image formation apparatus 200 are connected to a local area network (LAN) 104. The server 102 is a computer configured to provide a service in response to a request from a client apparatus such as the PC 101 or the image formation apparatus 200.

The PC 101 or the server 102 generates a print job including data described in a print language such as PDL following an operation by the user or data in a specific (compressed by JBIG or the like) data format. The PC 101 or the server 102 transmits the generated print job to the image formation apparatus 200 via the LAN 104. When the print job is received from the external apparatus such as the PC 101 or the server 102, the image formation apparatus 200 executes image formation (printing) following the received print job.

The PC 101 or the server 102 can remotely access the image formation apparatus 200 via the LAN 104. The PC 101 or the server 102 is configured to be able to perform an operation of the image formation apparatus 200 and monitoring of a state of the image formation apparatus 200 by the remote access. The image formation apparatus 200 is configured to be able to notify the external apparatus such as the PC 101 or the server 102 of a state of the image formation apparatus 200 itself.

### Configuration of the Image Formation Apparatus 200

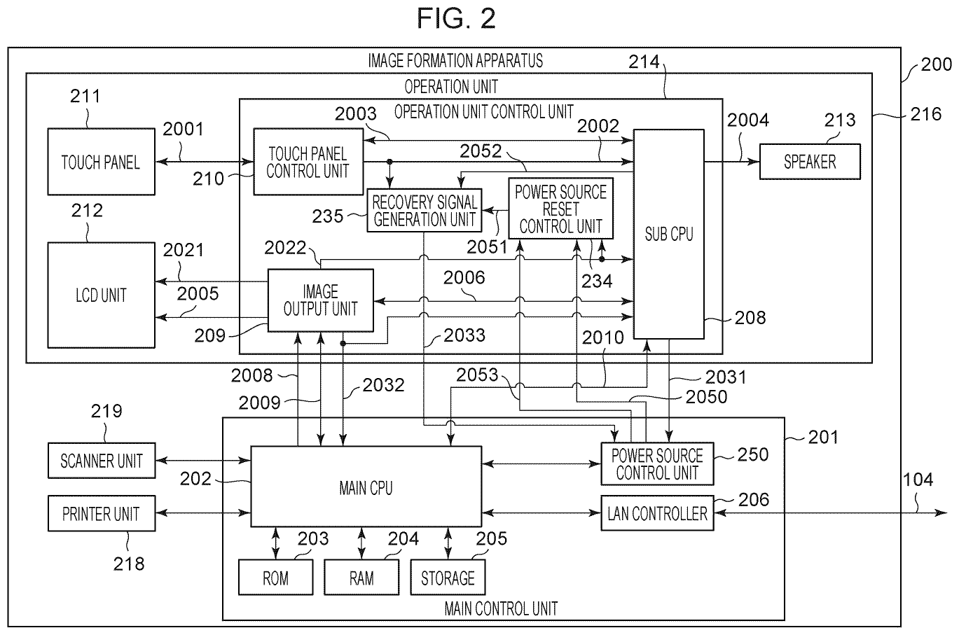

FIG. 2 is a block diagram illustrating a hardware configuration example of the image formation apparatus 200. The image formation apparatus 200 includes a main control unit 201, an operation unit 216, the printer unit 218, and a scanner unit 219.

The main control unit 201 includes a main CPU 202 (first CPU) and controls an entirety of the image formation apparatus 200.

The operation unit 216 functions as a user interface (UI) and includes a sub CPU 208 (second CPU), an input device (touch panel 211) configured to accept an operation by the user, and a display device (LCD unit 212) configured to display a screen. According to the present embodiment, the touch panel 211 and a touch panel control unit 210 are collectively referred to as an operation acceptance unit.

According to the present embodiment, the main control unit 201 functions as an example of the control unit configured to generate the image data for screen display on the LCD unit 212 to be output to the operation unit 216.

The operation unit 216 includes the LCD unit 212 (display unit) and functions as an example of the operation unit configured to display a screen on the LCD unit 212 (display unit) based on the image data generated by the main control unit 201 to accept a user operation.

It is noted that the image data for screen display is not limited to the configuration to be generated by the main control unit 201 as in the present embodiment but may be generated by the sub CPU 208 or the like in the operation unit 216.

The printer unit 218 performs image formation processing on a sheet-like recording medium (such as paper) according to an electrophotographic method. It is noted that the printer unit 218 may adopt not only the electrophotographic method but also the other recording method such as an ink-jet method or a thermal transfer method.

The main control unit 201 includes the main CPU 202, a ROM 203, a RAM 204, a storage 205, a LAN controller 206, and a power source control unit 250. The main control unit 201 realizes a print function by controlling the printer unit 218 such that an image is to be printed following the print job received from the external apparatus, for example. The main control unit 201 also realizes a copy function by controlling the scanner unit 219 and the printer unit 218 such that an image is to be printed based on image data obtaining by scanning an original image by the scanner unit 219.

The main CPU 202 controls the entirety of the image formation apparatus 200. The main CPU 202 realizes functions of the image formation apparatus 200 such as the print function and the copy function by reading out and executing a program stored in the ROM 203 or the storage 205. The RAM 204 is constituted by a volatile memory such as a double data rate synchronous dynamic random access memory (DDR SDRAM). The RAM 204 is used to store a program to be executed by the main CPU 202 and temporary data to be used by the main CPU 202. The storage 205 is a storage device such as a solid state drive (SSD) connected to the main CPU 202 by serial advanced technology attachment (serial ATA), for example. The storage 205 is used to temporarily store various setting information related to the image formation apparatus 200 and image data to be used by the print function or the copy function. The LAN controller 206 is connected to the main CPU 202 and the LAN 104. The LAN controller 206 controls communication with the external apparatus such as the PC 101 or the server 102 which is performed via the LAN 104.

The image formation apparatus 200 of the present embodiment has a first power save mode, a second power save mode, and a standby mode as operation modes. In the standby mode, power is supplied to the main CPU 202 from a power source (not illustrated) to put the main CPU 202 into an operative state.

In the first power save mode, power is not supplied to the main CPU 202 from the power source, and the main CPU 202 is not in an operative state. The first power save mode is an operation mode with lower power consumption of the image formation apparatus 200 than those in the second power save mode and the standby mode. It is noted that in the first power save mode, power supply is also stopped to devices such as the printer unit 218 and the scanner unit 219.

In the second power save mode, power is supplied to the main CPU 202 from the power source to put the main CPU 202 into a partially operative state. The second power save mode is an operation mode with lower power consumption of the image formation apparatus 200 than that in the standby mode but with higher power consumption of the image formation apparatus 200 than that in the first power save mode. It is noted that in the second power save mode too, power supply is also stopped to the devices such as the printer unit 218 and the scanner unit 219.

It is noted that according to the present embodiment, a power source (not illustrated) of the image formation apparatus 200 is provided in the main control unit 201.

The power source control unit 250 performs power source control on the entirety of the image formation apparatus 200. When power is not supplied to the main CPU 202 and the printer unit 218/the scanner unit 219, the power source control unit 250 performs ON/OFF control on the power source in the image formation apparatus 200 provided in the main control unit 201. When power is supplied to the main CPU 202 and the printer unit 218/the scanner unit 219, the main CPU 202 performs ON/OFF control on the power supply to each of the units by controlling the power source control unit 250. It is noted that the power source control by the power source control unit 250 may be realized when a CPU of the power source control unit executes a program or may be realized by a hardware logic such as a programmable logic device (PLD).

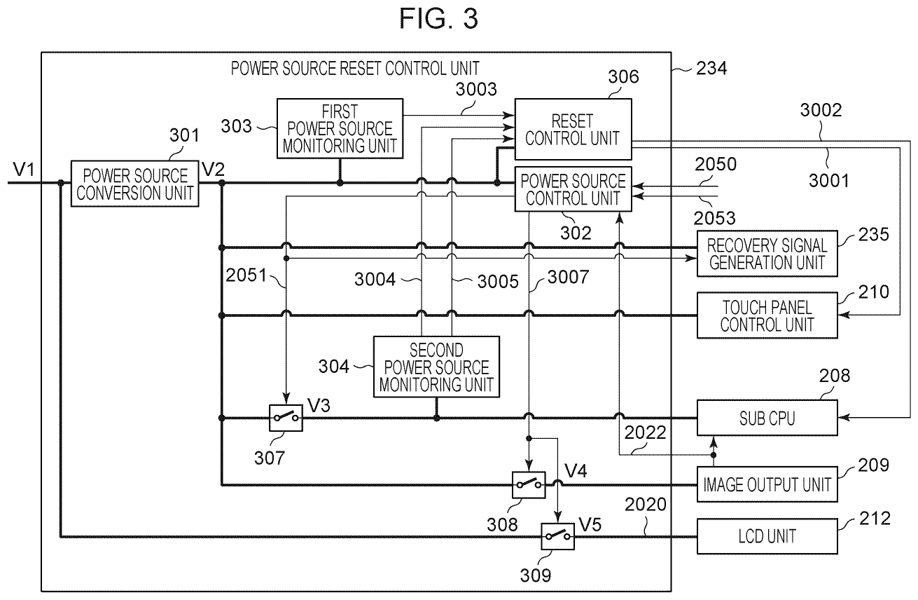

The power source control unit 250 performs the ON/OFF control on the power source in the image formation apparatus 200 in response to a recovery signal 2033 from the operation unit 216, a recovery signal (not illustrated) from the LAN controller 206, or the like as a trigger. With this configuration, the power source control unit 250 shifts the image formation apparatus 200 from the first and second power save modes to the standby mode. Furthermore, the power source control unit 250 controls power supply (power source) V1 (which will be described with reference to FIG. 3) to the operation unit 216.

The operation unit 216 is connected to the main control unit 201 via an image data signal 2008, a communication signal 2009, and a communication signal 2010. The operation unit 216 is further connected to the main control unit 201 via a READY signal 2031, a READY signal 2032, the recovery signal 2033, a first mode notification signal 2050, and a second mode notification signal 2053.

The READY signal 2031 is a signal indicating that the sub CPU 208 is in an operative state (state in which the communication signal 2010 can be received). The READY signal 2032 is a signal indicating that an image output unit 209 is in a state in which the communication signal 2009 and the image data signal 2008 can be received and is a signal of which the main CPU 202 and the sub CPU 208 in an operation unit 214 are notified from the image output unit 209.

The recovery signal 2033 is a signal for recovering the main control unit 201 (the image formation apparatus 200) from a sleep state (power save mode) and is transmitted from a recovery signal generation unit 235 to the power source control unit 250.

The first mode notification signal 2050 and the second mode notification signal 2053 are signals for notifying a power source reset control unit 234 in the operation unit 214 of a power mode of the main control unit 201 (the image formation apparatus 200). The signals are used for notification on whether the power mode here is the first power save mode, the second power save mode, or the standby mode.

The image output unit 209 of the operation unit 216 receives instructions or information from the main control unit 201 to perform display control on the LCD unit 212 via the image data signal 2008, the communication signal 2009, and the communication signal 2010.

The operation unit 216 also notifies, via the communication signal 2010, the main control unit 201 of the operation by the user which has been accepted via the touch panel 211.

The power source reset control unit 234 of the operation unit 216 determines (distinguishes) a current operation mode of the main control unit 201 by monitoring the first mode notification signal 2050 and the second mode notification signal 2053. Specifically, the operation unit 216 determines whether the operation mode of the main control unit 201 is in the first power save mode, the second power save mode, or the standby mode.

On the other hand, the main CPU 202 determines whether or not the sub CPU 208 is in an operative state (state in which the communication signal 2010 can be received) by monitoring the READY signal 2031. The main CPU 202 further determines whether or not the image output unit 209 can receive the communication signal 2009 and the image data signal 2008 by monitoring the READY signal 2032.

The operation unit 216 includes an operation unit control unit 214, the touch panel 211, the LCD unit 212, and a speaker 213.

The sub CPU 208, the touch panel control unit 210, the image output unit 209, the power source reset control unit 234, and the recovery signal generation unit 235 are installed in the operation unit control unit 214.

The touch panel control unit 210 is connected to the sub CPU 208 and to the touch panel 211 and the recovery signal generation unit 235.

Touch panel control unit 210 is also connected to the touch panel by a control signal 2001, and the touch panel control unit 210 senses a touch input on the touch panel 211 by monitoring the control signal 2001.

The touch panel control unit 210 also notifies, by using a touch sensing signal 2002, the sub CPU 208 and the recovery signal generation unit 235 of sensing information indicating that the touch input on the touch panel 211 has been performed by the user.

The touch panel control unit 210 also performs communication with the sub CPU 208 via a control signal 2003.

The sub CPU 208 is also referred to as an operation unit CPU. The sub CPU 208 transmits setting information for appropriately sensing the touch input by correcting touch sensitivity or touch coordinate misalignment on the touch panel 211 or the like to the touch panel control unit 210 via the control signal 2003.

The sub CPU 208 also receives, via the touch sensing signal 2002, sensing information indicating that the touch input on the touch panel 211 has been performed from the touch panel control unit 210.

Furthermore, when the sensing signal is received from the touch panel control unit 210, the sub CPU 208 reads out input operation data corresponding to the input operation by the user from the touch panel control unit 210 via the control signal 2003. The input operation data herein is data on touched coordinates, a press pressure, or the like.

The sub CPU 208 transmits the input operation data received from the touch panel control unit 210 to the main CPU 202 via the communication signal 2010.

The image output unit 209 is connected to the LCD unit 212 and controls image display on the LCD unit 212. That is, the image output unit 209 function as an example of an image output circuit configured to generate an image signal for screen display based on the image data received from the main control unit 201 to output the image signal to the LCD unit 212. The image output unit 209 controls the LCD unit 212 by using an image output signal 2005 and a backlight control signal 2021. The backlight control signal 2021 is used for ON/OFF control (turning-ON control) on a backlight of the LCD unit 212 and settings such as a brightness.

The image output unit 209 is connected to both the main CPU 202 and the sub CPU 208.

The image output unit 209 exchanges a control signal 2006 with the sub CPU 208. The image output unit 209 also exchanges the image data signal 2008, the communication signal 2009, and the READY signal 2032 with the main CPU 202.

The READY signal 2032 is a signal output from the image output unit 209 to the main CPU 202 and is used for notification on whether or not the image output unit 209 can receive the communication signal 2009 and the image data signal 2008.

An image reception ongoing signal 2022 is output from the image output unit 209 and used for notification on whether or not an image to be displayed on the LCD unit 212 based on the image data signal 2008 is received from the main CPU 202 to the image output unit 209.

The image reception ongoing signal 2022 is connected to not only the power source reset control unit 234 but also the sub CPU 208 such that the sub CPU 208 can monitor the image reception ongoing signal 2022.

The READY signal 2032 output from the image output unit 209 is also connected to not only the main CPU 202 but also the sub CPU 208 such that the sub CPU 208 can monitor the READY signal 2032. With this configuration, the sub CPU 208 can monitor the image reception ongoing signal (2022) and the READY signal (2032) indicating whether the image output unit can receive the image data.

The main CPU 202 transmits the image data of the screen to be displayed on the LCD unit 212 to the image output unit 209 installed in the operation unit control unit 214 as the image data signal 2008. The main CPU 202 transmits setting information for settings of the screen display such as a setting of a size or an orientation of the screen to be displayed on the LCD unit 212 to the image output unit 209 by using the communication signal 2009.

The image output unit 209 generates an image signal which can be received by the LCD unit 212 based on the image data received as the image data signal 2008 and the setting information received as the communication signal 2009 from the main CPU 202. The image output unit 209 transmits the generated image signal to the LCD unit 212 as the image output signal 2005. The image output unit 209 generates, for example, a low voltage differential signaling (LVDS) signal or an analog or digital RGB signal as the image signal which can be received by the LCD unit 212.

The LCD unit 212 displays the screen following the image output signal 2005 received from the image output unit 209.

After the image data and the setting information are received from the main CPU 202, when a state is established in which the image output to the LCD unit 212 can be performed, the image output unit 209 notifies the power source reset control unit 234 of the state by using the image reception ongoing signal 2022.

The sub CPU 208 performs the setting such as the ON/OFF control (turning-ON control) of the backlight of the LCD unit 212 and the brightness for the image output unit 209 via the control signal 2006.

The sub CPU 208 controls the speaker 213 by using a control signal 2004. For example, the sub CPU 208 causes the speaker 213 to output a push sound indicating acceptance of the user input and an audio indicating operation instructions for the user or information such as the state of the image formation apparatus 200. It is noted that the control on the speaker 213 may be performed by the main CPU 202 instead of the sub CPU 208.

The power source reset control unit 234 performs power source control and reset control on an entirety of the operation unit 216.

The power source reset control unit 234 monitors the first mode notification signal 2050 from the power source control unit 250 to distinguish whether or the main control unit 201 (the image formation apparatus 200) is in the first power save mode, the second power save mode, or the standby mode.

Thereafter, the power source reset control unit 234 performs the power source control on the entirety of the operation unit 216 by turning ON/OFF the power source in the operation unit 216 provided in the operation unit control unit 214. Then, similarly as in the main control unit 201, the operation unit 216 is shifted to the first power save mode or the second power save mode or shifted to the standby mode.

Furthermore, the power source reset control unit 234 notifies the recovery signal generation unit 235 of a power source control signal 2051 such that a recovery signal is generated according to whether the distinguished state of the image formation apparatus 200 is in the first power save mode, the second power save mode, or the standby mode.

The power source reset control unit 234 also generates a reset signal for a device in the operation unit control unit 214 by monitoring the ON/OFF state of the power source in the operation unit 216 provided in the operation unit control unit 214.

It is noted that the power source reset control by the power source reset control unit 234 may be realized by a hardware logic or may be realized when a CPU such as a microcomputer executes a program.

The recovery signal generation unit 235 receives information indicating a change in the user input on the touch panel 211 from the touch panel control unit 210 via the touch sensing signal 2002 from the touch panel control unit 210.

The recovery signal generation unit 235 generates the recovery signal 2033 based on the received touch sensing signal 2002, a recovery signal 2052 generated by the sub CPU 208, and furthermore, the power source control signal 2051 received from the power source reset control unit 234. Thus, by notifying the power source control unit 250 of the recovery signal 2033, the main control unit 201 (the image formation apparatus 200) is caused to recover from the first or second power save mode to the standby mode.

### Configuration of the Power Source Reset Control Unit 234

FIG. 3 is a block diagram illustrating a hardware configuration example of the power source reset control unit 234.

The power source reset control unit 234 includes a power source conversion unit 301, a power source control unit 302, a first power source monitoring unit 303, a second power source monitoring unit 304, a reset control unit 306, a switch 307, a switch 308, and a switch 309.

The power source reset control unit 234 is supplied with a power source V1 from the power source control unit 250 of the main control unit 201. Herein, a direct current at 12 V is set as an example of the power source V1.

The power source conversion unit 301 converts the supplied power source V1 into a power source V2. Herein, a direct current at 3.3 V is set as an example of the power source V2, and a regulator configured to decrease a voltage from 12 V to 3.3 V is set as an example of the power source conversion unit 301.

The power source V2 is supplied to the touch panel control unit 210, the recovery signal generation unit 235, the power source control unit 302, the first power source monitoring unit 303, and the reset control unit 306.

The power source control unit 302 monitors the first mode notification signal 2050 and the second mode notification signal 2053 from the power source control unit 250 and the image reception ongoing signal 2022 from the image output unit 209. The power source control unit 302 then generates the power source control signal 2051 for controlling ON/OFF of the switch 307 and a power source control signal (ON/OFF control signal) 3007 for controlling ON/OFF of the switch 308 and the switch 309.

The first power source monitoring unit 303 performs voltage monitoring of the power source V2 and monitors whether or not the power source V2 is stably supplied to notify the reset control unit 306 of a first power source state notification signal 3003.

The second power source monitoring unit 304 performs voltage monitoring of a power source V3 and monitors whether or not the power source V3 is stably supplied to notify the reset control unit 306 of a second power source state notification signal 3004.

The second power source monitoring unit 304 further monitors a behavior of a voltage of the power source V3 and notifies the reset control unit 306 of a second power source leading edge notification signal 3005 only when a leading edge of the power source V3 is detected.

The reset control unit 306 generates a reset signal 3001 to the touch panel control unit 210 and a reset signal 3002 to the sub CPU 208 based on the first power source state notification signal 3003, the second power source state notification signal 3004, and the second power source leading edge notification signal 3005.

The switch 307 generates the power source V3 to be supplied to the sub CPU 208 by turning ON/OFF the power source V2 based on the power source control signal 2051 from the power source control unit 302.

The switch 308 generates a power source V4 to be supplied to the image output unit 209 from the power source V2 based on the ON/OFF control signal 3007 from the power source control unit 302.

The switch 309 generates a power source V5 to be supplied to the LCD unit from the power source V1 based on the ON/OFF control signal 3007 from the power source control unit 302.

### Configuration of the Reset Control Unit 306

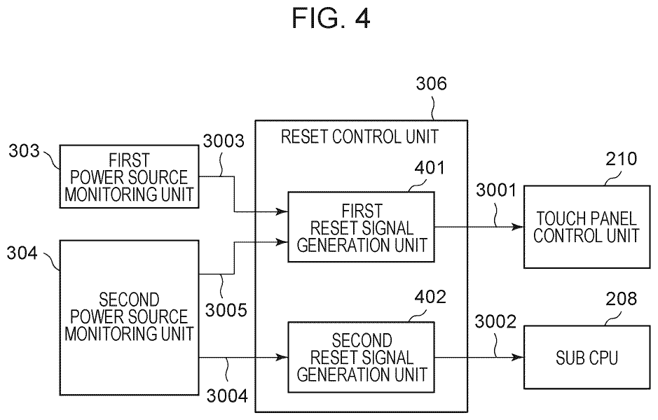

FIG. 4 is a block diagram illustrating a hardware configuration example of the reset control unit 306.

The reset control unit 306 is constituted by a first reset signal generation unit 401 and a second reset signal generation unit 402.

The first reset signal generation unit 401 generates the reset signal 3001 to the touch panel control unit 210 based on the first power source state notification signal 3003 from the first power source monitoring unit 303 and the second power source leading edge notification signal 3005 from the second power source monitoring unit 304.

The second reset signal generation unit 402 generates the reset signal 3002 to the sub CPU 208 based on the second power source state notification signal 3004 from the second power source monitoring unit 304.

### Configuration of the Recovery Signal Generation Unit 235

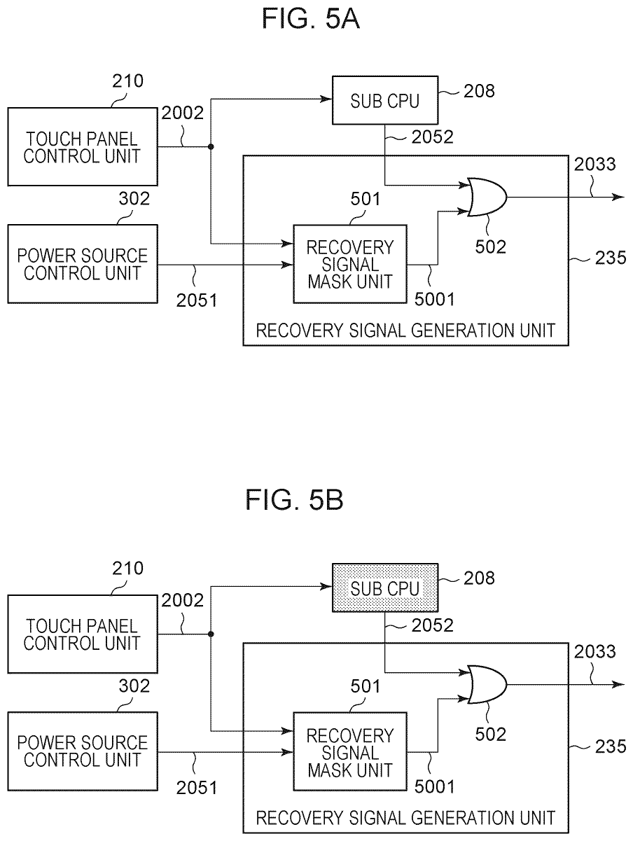

FIG. 5A is a block diagram illustrating a hardware configuration example of the recovery signal generation unit 235.

The recovery signal generation unit 235 is constituted by a recovery signal mask unit 501 and an OR gate 502.

The recovery signal mask unit 501 subjects the touch sensing signal 2002 from the touch panel control unit 210 to signal masking using the power source control signal 2051 from the power source control unit 302 to output a post-mask recovery signal 5001 to the OR gate 502.

When the power source control signal 2051 is ON, the recovery signal mask unit 501 masks the touch sensing signal 2002 to set the post-mask recovery signal 5001 to be disabled and output.

On the other hand, when the power source control signal 2051 is OFF, the recovery signal mask unit 501 does not mask the touch sensing signal 2002 to set the post-mask recovery signal 5001 to be enabled and output.

The OR gate 502 performs an OR operation between the recovery signal 2052 from the sub CPU 208 and the post-mask recovery signal 5001 from the recovery signal mask unit 501 to be output as the recovery signal 2033.

Herein, as an example of the recovery signal generation unit 235, the embodiment has been described in which the recovery signal mask unit 501 and the OR gate 502 are constituted by logic circuits and configured to receive the touch sensing signal 2002 to disable and output the post-mask recovery signal 5001. However, the recovery signal generation unit 235 is not limited to the described embodiment, and a CPU or the like may be used. An embodiment in which the touch sensing signal 2002 is received and ignored or an embodiment in which the touch sensing signal 2002 is not received in the first place may be adopted.

FIG. 5B is a block diagram illustrating an energized state of each of blocks connected to the recovery signal generation unit 235 in a first power saving state.

Here, an action of the recovery signal generation unit 235 in each of power states of the image formation apparatus will be described with reference to FIG. 5A and FIG. 5B.

First, when the image formation apparatus is in the standby mode, the sub CPU 208 is energized as illustrated in FIG. 5A, and the power source control signal 2051 from the power source control unit 302 is ON.

Therefore, the touch sensing signal 2002 which is input to the recovery signal mask unit 501 from the touch panel control unit 210 is masked by the recovery signal mask unit 501, and the post-mask recovery signal 5001 is set to be disabled and output.

On the other hand, the sub CPU 208 uses the touch sensing signal 2002 for a purpose as a trigger to read out the input operation data of the user which has been accepted by the touch panel 211 via the control signal 2003 from the touch panel control unit 210. This is because the touch sensing signal 2002 indicates that when the user touches the touch panel in a state in which an image is displayed on the LCD unit 212 in the standby mode, the touch input is performed on the touch panel.

For this reason, in the standby mode, even when the touch sensing signal 2002 is enabled, the sub CPU 208 sets the recovery signal 2052 to be disabled and output.

Next, when the image formation apparatus is in the first power save mode, the sub CPU 208 is not energized as illustrated in FIG. 5B, and the power source control signal 2051 from the power source control unit 302 is OFF.

Therefore, the touch sensing signal 2002 which is input to the recovery signal mask unit 501 from the touch panel control unit 210 is not masked by the recovery signal mask unit 501, and the post-mask recovery signal 5001 is set to be enabled and output.

When the image formation apparatus is in the second power save mode, the sub CPU 208 is energized as illustrated in FIG. 5A, and the power source control signal 2051 from the power source control unit 302 is ON.

Therefore, the touch sensing signal 2002 which is input to the recovery signal mask unit 501 from the touch panel control unit 210 is masked by the recovery signal mask unit 501, and the post-mask recovery signal 5001 is set to be disabled and output.

On the other hand, the sub CPU 208 uses the touch sensing signal 2002 to generate the recovery signal from the second power save mode. This is because the touch sensing signal 2002 indicates that when the user touches the touch panel in a state in which an image is not displayed on the LCD unit 212 in the second power save mode, an attempt is made to recover from the power save mode.

For this reason, in the second power save mode, when the touch sensing signal 2002 is enabled, the sub CPU 208 sets the recovery signal 2052 to be enabled and output.

### Timing Chart of Main Power Sources and Signals

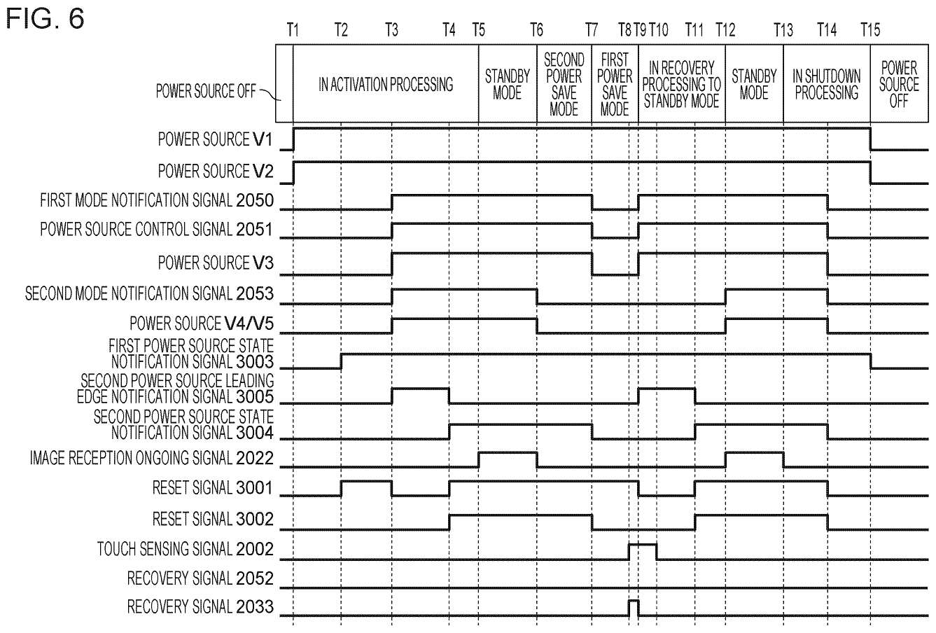

FIG. 6 is a timing chart illustrating behavior examples of internal signals and main power sources and signals which are input and output in the power source reset control unit 234.

At a time T1, when a power source switch (not illustrated) is turned ON by a user operation, first, the power source V1 is supplied from the power source control unit 250 of the main control unit 201, and the power source V2 is further generated from the power source V1 by the power source conversion unit 301, so that activation processing of the image formation apparatus is started.

At a time T2, when it is sensed that the power source V2 has started to be stably supplied, the first power source monitoring unit 303 changes the first power source state notification signal 3003 from LOW to HIGH to notify the reset control unit 306 of a state in which the power source V2 is stably supplied.

Furthermore, at the time T2, the first reset signal generation unit 401 in the reset control unit 306 senses that the first power source state notification signal 3003 has changed from LOW to HIGH. The first reset signal generation unit 401 then changes the reset signal 3001 to the touch panel control unit 210 from LOW to HIGH to be put into a reset release state from a reset state.

At a time T3, first, the power source control unit 250 of the main control unit 201 changes the output of the first mode notification signal 2050 and the output of the second mode notification signal 2053 from LOW to HIGH to notify the operation unit 216 that the main control unit 201 is in activation.

The power source reset control unit 234 of the operation unit 216 senses that the main control unit 201 is in activation since the output of the first mode notification signal 2050 and the output of the second mode notification signal 2053 have changed from LOW to HIGH at the same time. Furthermore, at the time T3, the power source control unit 302 of the operation unit 216 sets the first mode notification signal 2050 to HIGH from LOW. When it is sensed that the main control unit 201 is in activation, in order to turn the switch 307 ON, the power source control signal 2051 is set to HIGH from LOW to start the supply of the power source V3.

Furthermore, at the time T3, when it is sensed that the second mode notification signal 2053 has been set to HIGH from LOW, the power source control unit 302 changes the power source control signal 3007 from LOW to HIGH. With this configuration, the switch 308 and the switch 309 are turned ON to start the supply of the power source V4 and the power source V5.

Furthermore, at the time T3, when it is sensed that the supply of the power source V3 has been started, the second power source monitoring unit 304 changes the output of the second power source leading edge notification signal 3005 from LOW to HIGH. With this configuration, the reset control unit 306 is notified that the supply of the power source V3 has been started.

Furthermore, at the time T3, when it is sensed that the second power source leading edge notification signal 3005 has been changed from LOW to HIGH, the first reset signal generation unit 401 of the reset control unit 306 changes the output of the reset signal 3001 from HIGH to LOW. With this configuration, the touch panel control unit 210 is put into the reset state once.

At a time T4, when it is sensed that the power source V3 has started to be stably supplied, the second power source monitoring unit 304 changes the output of the second power source state notification signal 3004 from LOW to a HIGH state.

Furthermore, the output of the second power source leading edge notification signal 3005 is changed from HIGH to LOW to notify the reset control unit 306 that the power source V3 has started to be stably supplied.

Furthermore, at the time T4, the first reset signal generation unit 401 in the reset control unit 306 senses that the second power source leading edge notification signal 3005 has turned to LOW from HIGH. After that, the output of the reset signal 3001 to the touch panel control unit 210 is changed from LOW to HIGH again. With this configuration, the touch panel control unit 210 is released from the reset state.

Furthermore, at the time T4, the second reset signal generation unit 402 in the reset control unit 306 changes the output of the reset signal 3002 from LOW to HIGH to release the sub CPU 208 from the reset state.

With this configuration, when the mode shifts to the standby mode, not only the sub CPU 208 is reset, but also the touch panel control unit 210 can be reset.

At a time T5, when the display image for the LCD unit 212 is received from the main CPU 202, the image output unit 209 changes the image reception ongoing signal 2022 from LOW to HIGH. The image output unit 209 then performs notification indicating that the reception of the display image for the LCD unit 212 has been started from the main CPU 202, and further starts the display on the LCD unit 212.

The power source reset control unit 234 of the operation unit 216 senses that the operation mode of the image formation apparatus 200 has turned to the standby mode since the image reception ongoing signal 2022 has been changed from LOW to HIGH.

The activation of the image formation apparatus 200 is completed by the processing during a time period T1 to T5, and the operation mode of the image formation apparatus 200 during a time period T5 to T6 has turned to the standby mode.

At a time T6, the power source control unit 250 of the main control unit 201 performs the shifting to the second power save mode while a case when it is sensed that no operation has been performed for a certain time period in the standby mode or an instruction input for the shifting to the power save mode by the user is set as a trigger. Then, the main CPU 202 stops the transmission of the display image to the LCD unit 212.

Furthermore, at the time T6, the power source control unit 250 of the main control unit 201 changes the output of the second mode notification signal 2053 from HIGH to LOW to notify the operation unit 216 that the main control unit 201 shifts to the second power save mode.

The power source reset control unit 234 of the operation unit 216 senses that the mode shifts to the second power save mode when the output of the second mode notification signal 2053 changes from HIGH to LOW while the output of the first mode notification signal 2050 remains at HIGH.

Furthermore, at the time T6, when it is sensed that the transmission of the display image to the LCD unit 212 from the main CPU 202 has been stopped, the image output unit 209 of the operation unit 216 changes the image reception ongoing signal 2022 from HIGH to LOW. The image output unit 209 then notifies the sub CPU 208 that the transmission of the display image to the LCD unit 212 has been stopped.

Furthermore, at the time T6, when the second mode notification signal 2053 has been set to LOW from HIGH, the power source control unit 302 of the operation unit 216 changes the output of the power source control signal 3007 from HIGH to LOW. Then, the switch 308 and the switch 309 are turned OFF to interrupt the supply of the power source V4 and the power source V5.

Furthermore, at the time T6, the image display on the LCD unit 212 is also turned OFF since the supply of the power source V4 and the power source V5 has been interrupted.

The operation mode of the image formation apparatus 200 during a time period from T6 to T7 is set as the second power save mode.

At a time T7, the power source control unit 250 of the main control unit 201 changes the output of the first mode notification signal 2050 from HIGH to LOW in a case where it is sensed that no operation by the user has been performed for a certain time period in the second power save mode. The power source control unit 250 then performs notification indicating that the main control unit 201 shifts to the first power save mode.

Furthermore, at the time T7, when it is sensed that the first mode notification signal 2050 has been set to LOW from HIGH, the power source control unit 302 changes the output of the power source control signal 2051 from HIGH to LOW to turn the switch 307 OFF and interrupt the supply of the power source V3.

Furthermore, at the time T7, when it is sensed that the supply of the power source V3 has been interrupted, the second power source monitoring unit 304 changes the second power source state notification signal 3004 from HIGH to LOW to notify the reset control unit 306 that the supply of the power source V3 has been interrupted.

Furthermore, at the time T7, when it is sensed that the second power source state notification signal 3004 has been set to LOW from HIGH, the reset control unit 306 changes the output of the reset signal 3002 from HIGH to LOW to put the sub CPU 208 into the reset state.

The operation mode of the image formation apparatus 200 during a time period from T7 to T9 is set as the first power save mode.

At the time T7, the image formation apparatus 200 shifts to the first power save mode to put the sub CPU 208 into the reset state, but the reset signal 3001 to the touch panel control unit 210 remains in the reset release state. With this configuration, the touch panel control unit 210 keeps holding the setting information for sensing the touch input that has been set from the sub CPU 208 at the time of the standby mode even after the mode has been shifted to the first power save mode, and it becomes possible to detect the touch on the touch panel 211 under the appropriate setting.

At a time T8, when the touch input from the user on the touch panel 211 is detected, the touch panel control unit 210 changes the output of the touch sensing signal 2002 from LOW to HIGH for the recovery signal generation unit 235. With this configuration, the recovery signal generation unit 235 is notified that the touch panel 211 is being touched.

Furthermore, at the time T8, since the power source control signal 2051 is LOW, that is, since the power source V3 is OFF, the recovery signal mask unit 501 does not mask the touch sensing signal 2002 and enables the post-mask recovery signal 5001 to output HIGH. The OR gate 502 enables the recovery signal 2033 to output HIGH and instructs the power source control unit 250 of the main control unit 201 to recover to the standby mode. On the other hand, since the recovery signal 2052 that is output by the sub CPU 208 is in a disabled state since the power source V3 of the sub CPU 208 is OFF.

At a time T9, the power source control unit 250 of the main control unit 201 senses that the recovery signal 2033 from the operation unit 216 has been set to be enabled to HIGH. After that, the first mode notification signal 2050 is set as a HIGH output to notify the operation unit 216 that the mode is to be recovered to the standby mode.

Furthermore, at the time T9, when it is sensed that the first mode notification signal 2050 has been set to HIGH, the power source control unit 302 of the operation unit 216 sets the output of the power source control signal 2051 to HIGH and turns the switch 307 ON to start the supply of the power source V3.

Furthermore, at the time T9, when it is sensed that the supply of the power source V3 has been started, the second power source monitoring unit 304 changes the output of the second power source leading edge notification signal 3005 from LOW to HIGH to notify the reset control unit 306 that the supply of the power source V3 has been started. Furthermore, at the time T9, the first reset signal generation unit 401 of the reset control unit 306 senses that the second power source leading edge notification signal 3005 has been set to HIGH. After that, the first reset signal generation unit 401 changes the reset signal 3001 from HIGH to LOW to put the touch panel control unit 210 into the reset state once.

Furthermore, at the time T9, since the power source control signal 2051 has turned to HIGH, that is, since the power source V3 has turned ON, the recovery signal generation unit 235 masks the touch sensing signal 2002 and changes the recovery signal 2033 to LOW to be disabled and output.

At a time T10, the touch panel control unit 210 detects that the touch input from the user on the touch panel 211 has been released to notify the recovery signal generation unit 235 that the touch panel 211 is not touched. Specifically, the notification is performed by changing the touch sensing signal 2002 from HIGH to LOW.

At a time T11, when it is sensed that the power source V3 has started to be stably supplied, the second power source monitoring unit 304 changes the output of the second power source state notification signal 3004 from LOW to a HIGH state. Furthermore, the second power source leading edge notification signal 3005 is changed from HIGH to LOW to notify the reset control unit 306 that the power source V3 has started to be stably supplied.

Furthermore, at the time T11, the first reset signal generation unit 401 in the reset control unit 306 senses that the second power source leading edge notification signal 3005 has turned to LOW from HIGH. The first reset signal generation unit 401 then changes the output of the reset signal 3001 to the touch panel control unit 210 from LOW to HIGH again to release the touch panel control unit 210 from the reset state.

Furthermore, at the time T11, the second reset signal generation unit 402 in the reset control unit 306 changes the output of the reset signal 3002 from LOW to HIGH to release the sub CPU 208 from the reset state.

As the time of the first power save mode, since the touch panel control unit (slave device) is operating in a state in which the sub CPU (master device) does not exist, a setting value or a correction value for the touch panel control may be deviated. According to the above-described configuration, when the mode shifts from the first power save mode to the standby mode, not only the sub CPU 208 is reset, but also the touch panel control unit 210 can be reset. Thus, even if the setting value or the correction value is deviated at the time of the first power save mode, such a value can be restored to normal, and it is possible to continue the operation normally.

At a time T12, the power source control unit 250 of the main control unit 201 changes the output of the second mode notification signal 2053 from LOW to HIGH to notify that the activation processing of the main control unit 201 is completed and the mode has shifted to the standby mode.

Furthermore, at the time T12, when it is sensed that the second mode notification signal 2053 has been set to HIGH from LOW, the power source control unit 302 changes the power source control signal 3007 from LOW to HIGH. With this configuration, the switch 308 and the switch 309 are turned ON to start the supply of the power source V4 and the power source V5.

At the time T12, since the supply of the power source V4 and the power source V5 has been started, the image output unit 209 starts to display the display image received from the main CPU 202 on the LCD unit 212.

The image formation apparatus 200 completes the recovery processing from the first power save mode to the standby mode by the processing during a time period from T9 to T12. However, when the leading edge of the power source V3 of the sub CPU 208 is sensed, the reset signal 3001 to the touch panel control unit 210 is put into the reset state once. When the power source V3 has started to be stably supplied, the reset signal 3001 to the touch panel control unit 210 and the reset signal 3002 to the sub CPU 208 are put into the reset release state at the same time.

With this configuration, even in a case where the setting information or correction information for sensing the touch input which is held at the time of the first power save mode has been deviated, the touch panel control unit 210 can perform touch detection by being reset once. In other words, since the setting for sensing the touch input from the sub CPU 208 is made again by the resetting, even after the recovery to the standby mode, it becomes possible to detect the touch on the touch panel 211 under the appropriate setting.

The operation mode of the image formation apparatus 200 during a time period from T12 to T13 turns to the standby mode.

At the time T13, when the power source switch (not illustrated) is turned OFF by the user operation, first, the main control unit 201 starts shutdown processing of the image formation apparatus 200. The main CPU 202 then stops the transmission of the display image to the LCD unit 212 in the operation unit 216.

Furthermore, at the time T13, when it is sensed that the transmission of the display image to the LCD unit 212 from the main CPU 202 has been stopped, the image output unit 209 of the operation unit 216 further changes the image reception ongoing signal 2022 from HIGH to LOW. The image output unit 209 then notifies the sub CPU 208 that the transmission of the display image to the LCD unit 212 has been stopped.

At a time T14, the power source control unit 250 of the main control unit 201 changes the first mode notification signal 2050 and the second mode notification signal 2053 from HIGH to LOW at the same time. With this configuration, the power source control unit 250 notifies the operation unit 216 that the main control unit 201 is currently in the shutdown processing.

Furthermore, at the time T14, when the second mode notification signal 2053 has been set to LOW from HIGH, the power source control unit 302 of the operation unit 216 changes the output of the power source control signal 3007 from HIGH to LOW. With this configuration, the switch 308 and the switch 309 are turned OFF to interrupt the supply of the power source V4 and the power source V5.

Furthermore, at the time T14, since the supply of the power source V4 and the power source V5 is interrupted, the image display on the LCD unit 212 is also turned OFF.

Furthermore, at the time T14, when it is sensed that the mode notification signal 2050 has been set to LOW from HIGH, the power source control unit 302 of the operation unit 216 changes the output of the power source control signal 2051 from HIGH to LOW to turn the switch 307 OFF and interrupt the supply of the power source V3.

Furthermore, at the time T14, when it is sensed that the supply of the power source V3 has been interrupted, the second power source monitoring unit 304 changes the second power source state notification signal 3004 from HIGH to LOW to notify the reset control unit 306 that the supply of the power source V3 has been interrupted.

Furthermore, at the time T14, when it is sensed that the second power source state notification signal 3004 has been set to LOW from HIGH, the reset control unit 306 changes the output of the reset signal 3002 from HIGH to LOW to put the sub CPU 208 into the reset state.

At a time T15, first, the power source control unit 250 of the main control unit 201 interrupts the supply of the power source V1, and furthermore, the supply of the power source V2 converted by the power source conversion unit 301 of the operation unit 216 is also turned OFF.

The shutdown processing of the image output unit 209 is completed by the processing during a time period from T13 to T15.

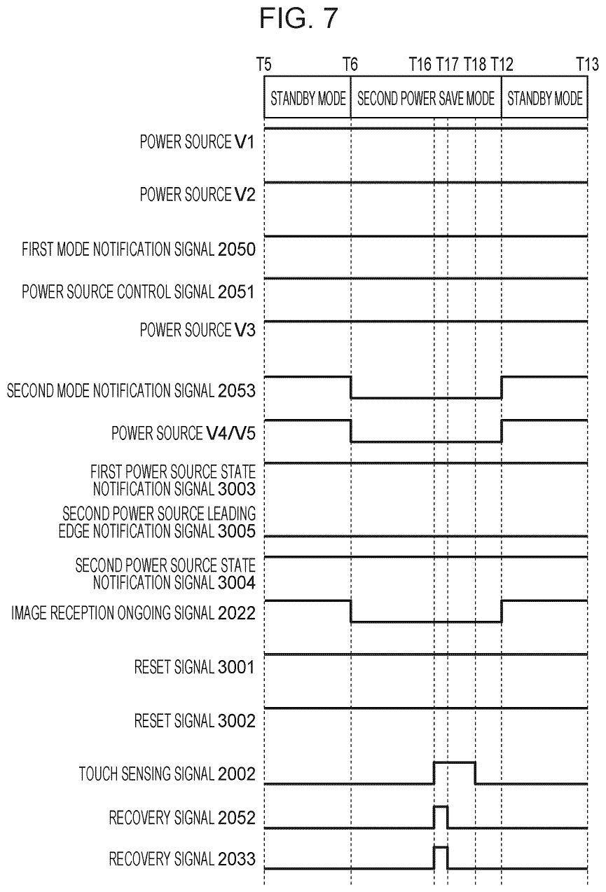

FIG. 7 is a timing chart illustrating behavior examples of the internal signals and the main power sources and signals which are input and output in the power source reset control unit 234. FIG. 6 is a timing chart in a case where the mode is shifted to the second power save mode and further shifted to the first power save mode to be then recovered to the standby mode. A difference from FIG. 6 is that FIG. 7 is a timing chart in a case where the mode is shifted to the second power save mode to be then recovered to the standby mode.

In addition, a difference from FIG. 6 resides in a period from T6 to T12, and a time period from T1 to T6 and a time period from T12 to T15 are similar to those in FIG. 6.

The time period from T5 to T6 in FIG. 7 is similar to that in FIG. 6, and the description thereof will not be repeated.

At a time T16, the touch panel control unit 210 detects that the touch input from the user is performed on the touch panel 211. After that, the output of the touch sensing signal 2002 is changed from LOW to HIGH to notify the sub CPU 208 and the recovery signal generation unit 235 that the touch panel 211 is being touched.

Furthermore, at the time T16, the recovery signal mask unit 501 of the recovery signal generation unit 235 masks the touch sensing signal 2002 since the power source control signal 2051 is HIGH, that is, since the power source V3 is ON. With this configuration, the post-mask recovery signal 5001 is disabled to output LOW.

Furthermore, at the time T16, when it is sensed that the touch sensing signal 2002 from the touch panel control unit 210 at the time of the second power save mode has been changed from LOW to HIGH, the sub CPU 208 sets the recovery signal 2052 to be enabled to output HIGH.

The power source reset control unit 234 of the operation unit 216 senses that the mode shifts to the second power save mode when the output of the first mode notification signal 2050 remains at HIGH and the output of the second mode notification signal 2053 is changed from HIGH to LOW.

Furthermore, at the time T16, since the OR gate 502 in the recovery signal generation unit 235 sets the recovery signal 2033 to be enabled to output HIGH since the recovery signal 2052 is enabled to be in a HIGH state.

At a time T17, the sub CPU 208 sets the recovery signal 2052 to be disabled for a certain time period, and furthermore, the recovery signal generation unit 235 sets the recovery signal 2033 to be disabled to output LOW.

At a time T18, when it is detected that the touch input from the user on the touch panel 211 is released, the touch panel control unit 210 notifies that the touch panel 211 is not touched.

Specifically, the touch sensing signal 2002 is changed from HIGH to LOW for the recovery signal generation unit 235.

The time T12 and the subsequent times are similar to those in FIG. 6, and the descriptions thereof will not be repeated.

In FIG. 7, to recover to the standby mode from the state in which the sub CPU 208 in the second power save mode is operating, the recovery signal 2033 is generated by the signal that has been output by the sub CPU 208.

On the other hand, in FIG. 6, to recover to the standby mode from the state in which the sub CPU 208 in the first power save mode is not operating, the recovery signal 2033 is generated by the signal that has been output by the recovery signal mask unit 501 in the recovery signal generation unit 235.

As described above, in the image formation apparatus 200 of the present embodiment, the power source reset control unit 234 controls OFF/ON of the power source to each of the devices in the operation unit 216 based on an output state of the mode notification signal from the main control unit 201. With this configuration, the power source control on the entirety of the operation unit 216 is performed.

With this configuration, in the first power save mode, the devices to be supplied with the power source in the operation unit are limited to the touch panel 211 and the touch panel control unit 210, the recovery signal generation unit 235, and the power source reset control unit 234. On the other hand, in the first power save mode, the recovery from the first power save mode to the standby mode can be performed by touching the touch panel.

In addition, with this configuration, power consumption can be reduced as compared with that in the second power save mode/the standby mode.

In addition, in the second power save mode, power is also supplied to the sub CPU 208 to put the sub CPU 208 into an operative state. Since it becomes possible for the touch panel control unit 210 to also obtain touched coordinates, the recovery to the standby mode by a recovery factor other than the touch sensing on the touch panel becomes possible. Recovery factors other than the touch sensing include, for example, the recovery to the standby mode by limiting a touch on a particular area, the recovery to the standby mode when a person is sensed by a human sensor which is not illustrated, and the like.

In this manner, recovery control for the first power save mode to the standby mode and recovery control for the second power save mode to the standby mode may be varied, and the recovery from the first power save mode and the recovery from the second power save mode may be realized in common by only the control signal from the recovery signal generation unit 235

Furthermore, in the image formation apparatus 200 of the present embodiment, the power source reset control unit 234 in the operation unit 216 performs the reset control based on the output state of the mode notification signal from the main control unit 201.

When the image formation apparatus 200 accordingly shifts to the first power save mode, the reset signal 3001 to the touch panel control unit 210 remains in the reset release state. Thus, the touch panel control unit 210 keeps holding the setting information for sensing the touch input that has been set from the sub CPU 208 at the time of the standby mode, and it becomes possible to detect the touch on the touch panel 211 under the appropriate setting.

In a case where the image formation apparatus 200 shifts from the first power save mode to the standby mode, when the leading edge of the power source V3 of the sub CPU 208 is sensed, the reset signal 3001 to the touch panel control unit 210 causes the touch panel control unit 210 to reset once. Then, once the power source V3 is started to be stably supplied, the reset signal 3001 to the touch panel control unit 210 and the reset signal 3002 to the sub CPU 208 are put into the reset release state at the same time.

With this configuration, even in a case where the setting information or the correction information for sensing the touch input which is held at the time of the first power save mode has been deviated, the touch panel control unit 210 can detect the touch on the touch panel 211 under the appropriate setting.

### Second Embodiment

Next, a second embodiment will be described with reference to the drawings. It is noted that the descriptions related to the configuration diagrams and the drawings of the flowcharts which have been described in the first embodiment will not be repeated.

Differences between the second embodiment and the first embodiment reside in FIG. 3, FIG. 4, and FIG. 6.

In a case where the mode is to be shifted from the first power save mode to the standby mode according to the first embodiment, the reset signal 3001 to the touch panel control unit 210 is put once into the reset state when the leading edge of the power source V3 of the sub CPU 208 is sensed. Then, once the power source V3 is started to be stably supplied, the reset signal 3001 to the touch panel control unit 210 and the reset signal 3002 to the sub CPU 208 have been put into the reset release state at the same time.

According to the second embodiment, when the mode is to be shifted from the first power save mode to the standby mode, the power source control unit 302 notifies the sub CPU 208 of the recovery from the first power save mode. Thus, the second embodiment is different from the first embodiment in that the sub CPU 208 resets the touch panel control unit 210 on a software basis via the control signal 2003.

First a difference of the second embodiment from the first embodiment in FIG. 3 and FIG. 4 resides only in the absence of the second power source leading edge notification signal 3005. The other components are similar to each other, and the descriptions thereof will not be repeated.

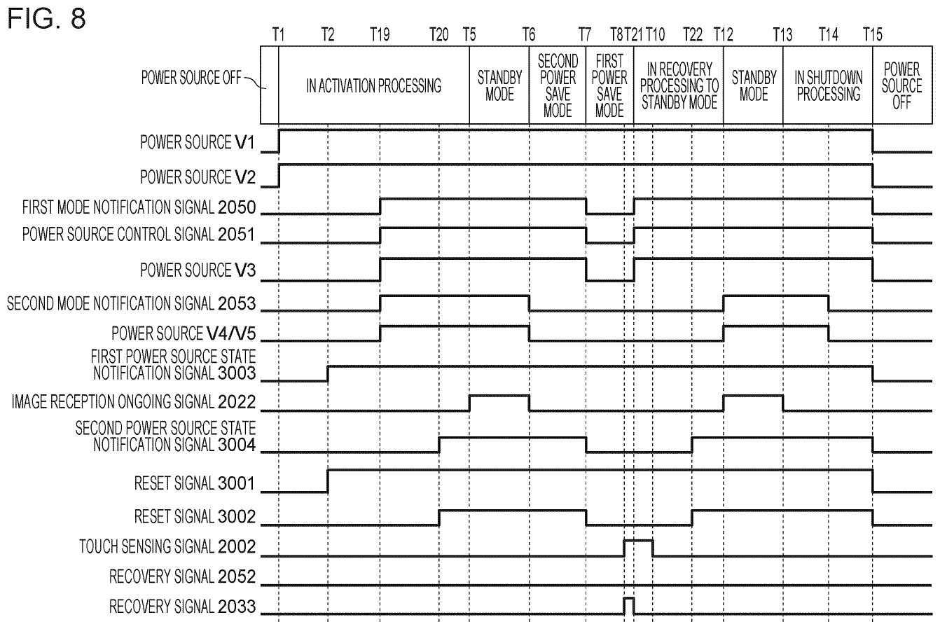

Next, the second embodiment will be described with reference to a flowchart in FIG. 8 instead of the flowchart in FIG. 6.

Differences between FIG. 6 and FIG. 8 reside in the times T3, T4, T9, and T11. The other times are similar to those in FIG. 6, and the descriptions thereof will not be repeated.

A time period from T1 to T2 is similar to that in FIG. 6, and the description thereof will not be repeated.

At a time T19, first, the power source control unit 250 of the main control unit 201 changes the output of the first mode notification signal 2050 and the output of the second mode notification signal 2053 from LOW to HIGH. Thus, the operation unit 216 is notified that the main control unit 201 is in activation.

Furthermore, at the time T19, when it is sensed that the first mode notification signal 2050 has been set to HIGH from LOW, in order to turn the switch 307 ON, the power source control unit 302 changes the power source control signal 2051 from LOW to HIGH to start the supply of the power source V3.

Furthermore, at the time T19, the power source control unit 302 senses that the second mode notification signal 2053 has been set to HIGH from LOW. After that, in order to turn the switch 308 and the switch 309 ON, the power source control signal 3007 is changed from LOW to HIGH to start the supply of the power source V4 and the power source V5.

At a time T20, when it is sensed that the power source V3 has started to be stably supplied, the second power source monitoring unit 304 sets the output of the second power source state notification signal 3004 to a HIGH state from LOW to notify the reset control unit 306 that the power source V3 has started to be stably supplied. Furthermore, at the time T20, the second reset signal generation unit 402 in the reset control unit 306 changes the reset signal 3002 to the sub CPU 208 from HIGH to LOW for the release from the reset state.

A time period from T5 to T8 is similar to that in FIG. 6, and the descriptions thereof will not be repeated.

At a time T21, the power source control unit 250 of the main control unit 201 senses that the recovery signal 2033 from the operation unit 216 has been set to be enabled to HIGH. The power source control unit 250 then changes the first mode notification signal 2050 from LOW to HIGH to notify the operation unit 216 that the mode is to be recovered to the standby mode.

Furthermore, at the time T21, when it is sensed that the first mode notification signal 2050 has been set to HIGH, the power source control unit 302 of the operation unit 216 sets the output of the power source control signal 2051 to HIGH to turn the switch 307 ON and start the supply of the power source V3.

Furthermore, at the time T21, since the power source control signal 2051 has turned to HIGH, that is, since the power source V3 has turned ON, the recovery signal generation unit 235 masks the touch sensing signal 2002 and changes the recovery signal 2033 to LOW to be disabled and output.

The time T10 is similar to that in FIG. 6, and the description thereof will not be repeated.

At a time T22, when it is sensed that the power source V3 has started to be stably supplied, the second power source monitoring unit 304 sets the output of the second power source state notification signal 3004 to a HIGH state from LOW to notify the reset control unit 306 that the power source V3 has started to be stably supplied.

Furthermore, at the time T22, the second reset signal generation unit 402 in the reset control unit 306 changes the output of the reset signal 3002 from LOW to HIGH to release the sub CPU 208 from the reset state.

Furthermore, at the time T22, the sub CPU 208 is released from being reset and transmits the READY signal 2031 to the main CPU 202 to notify that the sub CPU 208 is in an operative state (state in which the communication signal 2010 can be received).

Thereafter, the main CPU 202 notifies the sub CPU 208 of the recovery from the first power save mode via the communication signal 2010.

When the notification of the recovery from the first power save mode is received from the main CPU 202, the touch panel control unit 210 is additionally reset on a software basis via the control signal 2003. Furthermore, the setting information for appropriately sensing the touch input such as the correction of the touch sensitivity or touch coordinate deviations on the touch panel 211 is transmitted to the touch panel control unit 210.

The time T12 and the subsequent times are similar to those in FIG. 6, and the descriptions thereof will not be repeated.

As described above, in the image formation apparatus 200 of the present embodiment, when the mode is to be shifted from the first power save mode to the standby mode, the sub CPU 208 resets the touch panel control unit 210 on a software basis.

With this configuration, even in a case where the setting information or the correction information for sensing the touch input which is held at the time of the first power save mode has been deviated, the touch panel control unit 210 can detect the touch on the touch panel 211 under the appropriate setting.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-154188, filed Sep. 21, 2023, which is hereby incorporated by reference herein in its entirety.

What is claimed is:

1. An information processing apparatus, comprising:
an operation acceptance unit configured to accept an operation from a user;
a control unit configured to accept a signal from the operation acceptance unit;
a generation unit configured to accept a signal from the operation acceptance unit and generate a recovery signal; and
a power source control unit configured to shift, based on the recovery signal, a power state of the information processing apparatus from a first power state in which the control unit is not energized to a second power state in which the control unit is energized, wherein
the generation unit does not generate the recovery signal even when the signal from the operation acceptance unit is accepted in the second power state, and the generation unit generates the recovery signal when the signal from the operation acceptance unit is accepted in the first power state.

2. The information processing apparatus according to claim 1, wherein
when the signal from the operation acceptance unit is accepted in the second power state, the generation unit does not generate the recovery signal by generating a disabled signal.

3. The information processing apparatus according to claim 1, wherein
in the second power state, the generation unit does not generate the recovery signal by rejecting the signal from the operation acceptance unit.

4. The information processing apparatus according to claim 1, wherein
in the second power state, the generation unit does not generate the recovery signal by disabling the signal accepted from the operation acceptance unit.

5. The information processing apparatus according to claim 1, wherein
the operation acceptance unit is constituted by a touch panel configured to accept an operation from the user and a touch panel control unit configured to monitor the operation from the user on the touch panel, and
when the operation from the user on the touch panel is sensed, the touch panel control unit outputs sensing information for notification of touch sensing and information of coordinates where the operation is accepted.

6. The information processing apparatus according to claim 5, wherein
the touch panel control unit is connected to the control unit and the generation unit, and
when the operation from the user on the touch panel is sensed, the touch panel control unit transmits the sensing information for the notification of the touch sensing to the control unit and the generation unit.

7. The information processing apparatus according to claim 5, further comprising:
a reset unit configured to reset the control unit and the touch panel control unit, wherein
when the information processing apparatus shifts from the first power state to the second power state, the reset unit resets the control unit and the touch panel control unit.

8. The information processing apparatus according to claim 1, further comprising:
a main control unit configured to control an operation of the information processing apparatus, wherein
the main control unit notifies the control unit of the power state of the information processing apparatus.

9. The information processing apparatus according to claim 8, further comprising:
a power supply unit configured to supply power from a power source, wherein
the power supply unit controls power supply to the control unit based on the notification of the power state from the main control unit.

10. A control method for an information processing apparatus which includes an operation unit, an operation unit CPU, and a signal generation unit, the control method comprising:
outputting, when the operation unit accepts an operation from a user, a signal to the operation unit CPU and the signal generation unit;
generating, by the signal generation unit which has received the signal, a recovery signal; and
shifting, based on the recovery signal, a power state of the information processing apparatus from a first power state in which the operation unit CPU is not energized to a second power state in which the operation unit CPU is energized, wherein
the signal generation unit does not generate the recovery signal even when the signal is accepted in the second power state, and the signal generation unit generates the recovery signal when the signal is accepted in the first power state.

11. A non-transitory computer-readable storage medium storing a program for causing an information processing apparatus to perform control method for an information processing apparatus which includes an operation unit, an operation unit CPU, and a signal generation unit, the control method comprising:
outputting, when the operation unit accepts an operation from a user, a signal to the operation unit CPU and the signal generation unit;
generating, by the signal generation unit which has received the signal, a recovery signal; and
shifting, based on the recovery signal, a power state of the information processing apparatus from a first power state in which the operation unit CPU is not energized to a second power state in which the operation unit CPU is energized, wherein
the signal generation unit does not generate the recovery signal even when the signal is accepted in the second power state, and the signal generation unit generates the recovery signal when the signal is accepted in the first power state.
